(19) United States
(12) Patent Application Publication
(10) Pub. No.: US 2009/0274616 A1
(43) Pub. Date: Nov. 5, 2009

(54) ZEOLITE MEMBRANES FOR HYDROGEN GAS PRODUCTION AND METHOD OF PRODUCING HYDROGEN GAS USING THE ZEOLITE MEMBRANES

(75) Inventors: Michihiro Miyake, Okayama-shi (JP); Motohide Matsuda, Okayama-shi (JP); Hitoshi Inokawa, Okayama-shi (JP); Yoshio Nakano, Himeji-shi (JP); Shin-ichiro Goto, Himeji-shi (JP); Kenzo Kimura, Kanzaki-gun (JP)

Correspondence Address: JHK LAW, P.O. BOX 1078, LA CANADA, CA, 91012-1078, US

(73) Assignee: NICHIRIN CO., LTD., Himeji-shi (JP)

(21) Appl. No.: 12/045,405

(22) Filed: Mar. 10, 2008

(30) Foreign Application Priority Data
Aug. 30, 2007 (JP) JP2007-224244

(51) Int. Cl. C01B 3/16; B01J 20/28; B01J 8/00

(52) U.S. Cl. 423/657; 502/4; 422/187

(57) ABSTRACT

To provide a method for manufacturing zeolite membrane that has characteristics of being resistant to the reaction for a long time and in the high-temperature range, and has characteristic of long-duration hydrogen generation. The inventors of the present invention successfully produced a highly dense zeolite membrane by the steps of: evacuating the surface of porous support not adding the zeolite seed crystals dropwise, thus densely filling the seed crystals in the micropores; and applying hydrothermal treatment to the seed crystals. In addition, the inventors of the present invention confirmed that the zeolite membrane manufactured by the above methods has the characteristic of generating hydrogen for a long time.

### FIELD OF THE INVENTION

The present invention relates to a zeolite membrane for generating hydrogen, a method for generating hydrogen by water heat decomposition using the membrane, an apparatus for carrying out the method, and a system for generating hydrogen.

The application claims the priority of Japanese Patent Application No. 2007-224244 which is incorporated herein as a reference.

### RELATED BACKGROUND OF THE INVENTION

Since hydrogen generates only water as a combustion product, it draws keen attention as a high-quality energy source and further as a clean energy source owing to the physical properties thereof. Thus, varieties of methods for manufacturing hydrogen have been studied in recent years. As of these methods, the one producing hydrogen from water as a raw material is highly expected to put into practical use owing to the low environmental load.

Nevertheless, system that generates hydrogen at low cost, stably, and with high efficiency remains uncompleted.

There are known methods for manufacturing hydrogen, such as electrolysis of water and thermochemical cycle. The electrolysis of water is somewhat less than effective because of imbalance between the electricity necessary for electrolysis and the available hydrogen energy.

There are proposed various thermochemical cycle methods exemplified below. They each have problems remaining.

The steam reforming method is the method to obtain hydrogen by the reaction between methane gas and steam heated to a temperature of 700° C. to 800° C. The method has drawbacks of high reaction temperature, accompanying emissions of carbon dioxide, and increased scale of facilities.

The carbon monoxide-conversion reaction (CO+H₂O→CO₂+H₂) is conducted using an iron oxide (Fe₃O₄) catalyst or a zinc oxide-copper-based catalyst. The reaction also has problems of high reaction temperature and accompanying emissions of carbon dioxide.

The direct water-splitting method using triiron tetroxide (Fe₃O₄) is composed of eight iron-steam-based processes. The reaction has problems of high reaction temperature for deoxidizing Fe₃O₄ to generate FeO, and of complicated apparatus owing to combinations of multi-stage reactions.

In addition, there are many hydrogen generation methods carried out by water splitting using a catalyst (iron oxide or ferrite), (refer to Patent Documents 1, 2, 3, and 4).

Any of above methods, however, has problems of the reaction temperature and the efficiency of hydrogen generation.

There are also reported the methods for generating hydrogen by water splitting using zeolite as a catalyst, (refer to Patent Documents 5, 6, and 7).

According to the method disclosed in Patent Documents 5 and 6, natural zeolite powder is placed in a reactor vessel, and the reactor vessel is brought to vacuum state, then the zeolite powder is brought into contact with steam at temperatures ranging from 300° C. to 600° C., and then the hydrogen is separated from the steam molecules.

According to the method disclosed in Patent Document 7, hydrogen is generated by splitting water using granulated natural zeolite powder, which is previously addition of a metallic halide, as a catalyst.

Above methods using zeolite powder as a catalyst do not clearly determine the role of zeolite in the water-splitting reaction, or do not clearly identify whether the micropores in zeolite contribute to the water-splitting reaction or not. In addition, hydrogen generation is detected in a closed system (a system without supplying steam to the reactor vessel continuously, or a system in which steam is once supplied to the reactor vessel, and then the valve of the reactor vessel is closed to let the reaction proceed for a specified period). In particular, the confirmation of hydrogen generation is made after 1 or 2 hours of reaction. According to the results obtained by the examples (refer to FIGS. 4 and 5), very high concentration of hydrogen is detected within a period of initial several hours in the hydrogen generation from zeolite. These results suggest that through the catalytic action of zeolite, not only was supplied water split, but also the splitting of adsorbed water existed within the zeolite contributed to the increased concentration of hydrogen. Since the methods using zeolite powder as the catalyst, described in Patent Documents 5 to 7, make confirmations of hydrogen generation only after 1 hour or 2 hours of reaction, it is doubtful whether the hydrogen generation is sustainable. Furthermore, since natural zeolite is used as the sample, hydrogen generation caused by varieties of existing impurities cannot be denied.

On the other hand, methods for preparing zeolite membrane, including the Secondary growth method, the Dry conversion method, and the electrophoresis are known, (refer to Patent Documents 8, 9, and 10).

According to Patent Document 8, zeolite seed crystals are attached to the surface and into the micropores of a porous substrate, and the hydrothermal method is carried out to form the zeolite membrane on the surface and into the micropores of the substrate.

According to Patent Document 9, a porous substrate is immersed in a solution containing zeolite seed crystals to attach the zeolite seed crystals to the surface and into the micropores of the substrate, and the hydrothermal method is carried out to form the zeolite membrane, which is applicable at about 100° C., on the surface and into the micropores of the substrate.

Above Patent Documents, however, do not disclose and/or suggest the use of zeolite membrane as a catalyst for hydrogen generation. Furthermore, the zeolite membrane prepared by the above methods has a problem of heat resistance making it possible to function as a catalyst for hydrogen generation, specifically a problem of not being resistant to the long periods of use in the high-temperature range of 100° C. or above.

As a result of above related art, there is no available method for generating hydrogen for a long time and in a stable state using zeolite membrane.

[Patent Document 1] Japanese Unexamined Patent Publication No. 2004-231459

[Patent Document 2] Japanese Unexamined Patent Publication No. 2004-269296

[Patent Document 3] Japanese Unexamined Patent Publication No. 2006-298658

[Patent Document 4] Japanese Unexamined Patent Publication No. 2006-298660

[Patent Document 5] Japanese Unexamined Patent Publication No. 11-171501

[Patent Document 6] WO98/51612

[Patent Document 7] WO01/87769

[Patent Document 8] Japanese Unexamined Patent Publication No. 2007-61775

[Patent Document 9] Japanese Unexamined Patent Publication No. 2005-53747

[Patent Document 10] Japanese Unexamined Patent Publication No. 2006-159144

### SUMMARY OF THE INVENTION

To solve the above problems of related art, the present inventors investigated the method for forming zeolite membrane used for generating hydrogen, specifically the present inventors addressed providing a method for manufacturing zeolite membrane that has characteristics of being resistant to the reaction for a long time and in the high-temperature range and also has characteristics of long-duration hydrogen generation. Furthermore, the present inventions addressed providing a method for generating hydrogen for a long time using the zeolite membrane.

To solve the above problems, the present inventors conducted detail studies, and successfully produced a highly dense zeolite membrane by generating a pressure difference between a surface of the porous support with zeolite seed crystals attached and a surface thereof without zeolite seed crystals attached, thereby filling the micropores of the porous support with the zeolite seed crystals through the use of the pressure difference; and applying the hydrothermal treatment. Furthermore, the inventors of the present invention confirmed that the zeolite membrane obtained by the above production method has characteristic of generating hydrogen for a long time.

That is, the present invention is as follows.

1. A method for generating hydrogen has the step of bringing water or a water-containing gas, or steam or a steam-containing gas, into contact with a zeolite membrane, thereby splitting the water or the steam using the zeolite membrane as a catalyst.

2. The method for generating hydrogen according to item 1, wherein the zeolite membrane contains a porous support and a zeolite layer produced on either surface of the porous support and in micropores thereof.

3. The method for generating hydrogen according to item 2, wherein the step of manufacturing the zeolite membrane has the steps of: attaching zeolite seed crystals to either surface of the porous support; and generating a pressure difference between the surface with zeolite seed crystals attached and the surface without zeolite seed crystals attached, thereby filling the micropores of the porous support with the zeolite seed crystals through the use of the pressure difference.

4. The method for generating hydrogen according to any one of item 1 to item 3, wherein the contact temperature of the zeolite with the water or the water-containing gas or with the steam or the steam-containing gas is in the range of 400° C. to 800° C.

5. A material for generating hydrogen has a zeolite membrane having a porous support and a zeolite layer produced on either surface of the porous support and in micropores thereof.

6. The material for generating hydrogen according to item 5, wherein the zeolite layer is produced in the micropores by the steps of: attaching zeolite seed crystals to either surface of the porous support; and generating a pressure difference between the surface with zeolite seed crystals attached and the surface without zeolite seed crystals attached, thereby filling the micropores of the porous support with the zeolite seed crystals through the use of the pressure difference.

7. The material for generating hydrogen according to item 5 or item 6, wherein the mean micropore size of the porous support is in the range of 200 nm to 5 mm, and the mean grain size of the zeolite seed crystals is in the range of 200 nm to 700 nm.

8. An apparatus for generating hydrogen has, at least: a water-supply means which supplies water or steam to a reactor vessel; a zeolite membrane; a reactor vessel containing the zeolite membrane; and a hydrogen-extraction means which extracts hydrogen generated in the reactor vessel therefrom.

9. A system for generating hydrogen having the apparatus for generating hydrogen according to 8, wherein the reactor vessel containing the zeolite membrane is kept at temperatures ranging from 400° C. to 800° C., and water or steam is continuously supplied to the reactor vessel, thus generating hydrogen continuously for at least 10 hours.

10. The system for generating hydrogen according to item 9, wherein the zeolite membrane contains a porous support and a zeolite layer produced on either surface of the porous support and in micropores thereof.

11. The system for generating hydrogen according to item 10, wherein the zeolite layer is produced in the micropores by the steps of: attaching zeolite seed crystals to either surface of the porous support in the zeolite membrane; and generating a pressure difference between the surface with zeolite seed crystals attached and the surface without zeolite seed crystals attached, thereby filling the micropores of the porous support with the zeolite seed crystals through the use of the pressure difference.

### EFFECT OF THE INVENTION

In the method for generating hydrogen by water splitting using the zeolite membrane according to the present invention, it was confirmed that the hydrogen generation is possible in a sustainable and that the zeolite micropores contribute to the water-splitting reaction. Furthermore, the zeolite membrane produced by the present invention is applicable in the high-temperature range of 100° C. or above, and is able to generate hydrogen with high efficiency.

### DESCRIPTION OF THE PREFERRED EMBODIMENTS

(Method for Generating Hydrogen (Gas) According to the Present Invention)

According to the present invention, the zeolite membrane at a temperature ranging from 400° C. to 800° C. is brought into contact with steam or water, and then hydrogen is separated from steam molecule or water molecule, thus obtaining hydrogen.

(Reaction Temperature)

The contact temperature of the zeolite membrane of the present invention with steam or water is approximately from 400° C. to 800° C., preferably approximately from 420° C. to 700° C., and more preferably approximately from 440° C. to 600° C.

Excessively high contact temperature induces cracks on the zeolite membrane, which fails to generate hydrogen for a long time and with high efficiency. Excessively low contact temperature fails to generate hydrogen.

(Pressure)

The pressure at the time of contact between the zeolite of the present invention and steam or water may be atmospheric pressure as normal pressure. Since the reaction according to the present invention does not need to apply external pressure and does not need to conduct the reaction under high pressure, the present invention has economical advantage.

(Applied Carrier Gas)

The carrier gas (gas) used in the present invention may be helium, neon, or argon, which are the rare gases, or nitrogen, or air.

(Porous Support)

Materials for porous support include ceramics, organic polymer, and metal. Applicable ceramics include mullite, alumina, silica, titania, and zirconia. Applicable metal includes stainless steel. For the material of porous support, ceramics are preferred because of little elution in liquid and of being stable at high temperature, and specifically alumina is preferred.

The mean micropore size of the porous support is in the range of 200 nm to 5 μm, preferably of 300 nm to 4 μm, and more preferably of 400 nm to 2 μm.

The porosity of the porous support is preferably in the range of 40 to 60%, and more preferably of 45 to 50%.

The shape of the porous support includes flat sheet, tube, cylinder, hollow fiber, honeycomb, and pellet. As of these, specifically preferred shape is flat sheet (disk).

The size of the porous support is not specifically limited, but depends on the size of applied reactor vessel. For flat disk shape, for example, the diameter is in the range of about 5 mm to about 10 cm, preferably of 10 mm to 5 cm, with the thickness in the range of 0.5 mm to 1 cm, preferably of 1 mm to 5 mm.

(Zeolite)

Applicable zeolite includes varieties of hydrophilic and hydrophobic zeolites.

The hydrophilic zeolites include A-type, X-type, Y-type, L-type, and P-type. The hydrophobic zeolites include high-silica ZSMs, high-silica Y-type, mordenites, and silicalite.

The thickness of zeolite layer with which the substrate was filled from surface thereof is preferably in the range of 5 to 15 μm, and more preferably of 6 to 10 μm.

As the alkali component as a raw material of zeolite, normally sodium hydroxide can be used, and potassium hydroxide and lithium hydroxide can also be used. Applicable silica component includes sodium silicate, water glass, colloidal silica, and hydrolysate of alkoxy silane. Applicable alumina component of zeolite includes sodium aluminate, aluminum hydroxide, aluminum nitrate, aluminum chloride, and boehmite. As a structure-regulating agent, organic compounds such as tetrapropyl ammonium hydroxide, tetramethyl ammonium hydroxide, and pyrrolidine are used, if necessary.

(Zeolite Membrane of the Present Invention)

Common practice of producing the zeolite membrane is to immerse a porous support having zeolite seed crystals attached to the surface or in the vicinity of the surface thereof in a solution containing a raw material of zeolite, thus conducting hydrothermal reaction. According to the method, when the porous support is immersed in the solution, the zeolite seed crystals attached to the porous support dissolve to form a supersaturated region in the peripheral area, thus forming nuclei. Centering on the seed crystals and nuclei produced at peripheral area thereof, the zeolite crystals grow through the hydrothermal reaction, thereby forming the zeolite layer on the surface of the porous support.

When the zeolite seed crystals attach to the porous support, if the diameter of zeolite seed crystals used are larger than that of micropores of the porous support, the zeolite seed crystals deposit only on the surface of the porous support, and thus the zeolite layer was produced on the surface of the porous support through the hydrothermal reaction.

If the zeolite membrane having the zeolite layer on the surface of the porous support is used in the high-temperature range, a problem occurs that by heat treatment, the cracks generated on the zeolite membrane turns to through-holes.

To the contrary, according to the method for producing zeolite membrane of the present invention, seed crystals of zeolite are brought into contact with the surface of the porous support substrate in order to form the zeolite layer on the surface and in the micropores of the porous support, and then a pressure difference is generated between the surface with zeolite seed crystals attached and the surface without zeolite seed crystals attached, thereby densely filling the zeolite seed crystals in the micropores of the substrate through the use of the pressure difference, and further applying hydrothermal treatment to produce the zeolite membrane. When the dense zeolite layer is produced within the micropores of the porous support by the above procedure, the generation of through-holes can be prevented because cracks generated during the use in the high-temperature range is suppressed by the support.

Owing to the above advantage, the zeolite membrane according to the present invention achieves high denseness, and further the duration of hydrogen generation for the zeolite membrane of the present invention increases.

The inventors of the present invention have already confirmed that the zeolite membrane of the present invention has a heat resistance tolerant of 400° C. or higher temperatures, compared with conventional zeolite membranes.

The mean grain size of zeolite seed crystals is preferably in the range of 200 to 700 nm, and more preferably of 300 to 600 nm.

The zeolite seed crystals may not necessarily be the same kind as the target zeolite, and may be different kind therefrom if only the crystal structure is similar to that of zeolite.

The method for attaching the zeolite seed crystals to the porous support includes the one to bring slurry containing the zeolite seed crystals into contact with the porous support, and the one to rub the zeolite seed crystals directly on the porous support. The method of bringing the slurry containing the zeolite seed crystals into contact with the porous support includes the dip-coating method (the porous support is immersed in the slurry, and then is pulled up), the spin-coating method (the slurry is added dropwise onto the rotating porous support), the spray-coating method (the slurry is sprayed on the porous support), the coating method, and the filtration method. The time of bringing the slurry into contact with the porous support is preferably from 0.5 to 60 minutes, and more preferably from 1 to 10 minutes.

(Method for Separating Hydrogen)

The generated hydrogen can be separated by a known method at high concentration from the gas passed through the zeolite membrane. Applicable separation apparatus includes membrane separator and pressure-swing (PSA) separator.

(Apparatus for Generating Hydrogen of the Present Invention)

The apparatus for generating hydrogen according to the present invention has: a steam-generating means for generating steam from water; a steam-supply means which supplies steam generated from the steam-generating means to a reactor vessel; a zeolite membrane; the reactor vessel containing the zeolite membrane; and a gas-extraction means which extracts hydrogen gas generated in the reactor vessel therefrom.

When the steam is directly supplied to the reactor vessel, the above steam-generation means is not needed.

The type of reactor vessel may be vertical type or horizontal type. In the case of vertical reactor vessel, the steam-supply means is efficiently connected to upper portion (or lower portion) of the reactor vessel, while the gas-extraction means is connected to the lower portion (or the upper portion) thereof. In the case of horizontal reactor vessel, the steam-supply means is efficiently connected to one side of the reactor vessel, while the gas-extraction means is connected to the other side of the reactor vessel.

FIG. 1 shows an example of the apparatus for generating hydrogen according to the present invention. Argon gas as a carrier gas is supplied to a steam generator 2 via a flow meter 1.

A pipe 3 is connected to the steam generator 2 to discharge the generated steam together with the carrier gas A preheater 11 is mounted on the pipe 3. The end of the pipe 3 is connected to the upper portion of a vertical reactor vessel 4.

For the case of horizontal reactor vessel, the end of the pipe 3 is connected to a side of the horizontal reactor vessel.

The apparatus for generating hydrogen according to the present invention preferably uses a disk-shaped zeolite membrane 5. The zeolite membrane 5 is fit in a stainless steel gasket 9 (a flat disk in a washer-like shape, with a center hole). The gap between the gasket 9 and the zeolite membrane 5 is sealed by a ceramic heat-resistant bond 10. Subsequently, the zeolite membrane 5 is installed in the reactor vessel 4 so that the gasket portion is sandwiched between stainless steel tubes, (refer to FIG. 1).

The reactor vessel 4 contains one or more sheets of zeolite membrane 5. A heater 6 is located around the reactor vessel 4. A pipe 7 is connected to the lower end of the reactor vessel 4. A steam trap 8 is connected to the pipe 7 to remove un-reacted steam. A gas chromatograph or a hydrogen recovery unit is connected behind the steam trap 8.

(Material for Generating Hydrogen According to the Present Invention)

The material for generating hydrogen according to the present invention has a zeolite membrane composed of a porous support and a zeolite layer produced on either surface of the porous support and in micropores thereof.

Specifically for producing the zeolite layer in the micropores of the porous support, the zeolite layer is produced in the micropores by the steps of: attaching the zeolite seed crystals to either surface of the porous support; and generating a pressure difference between the surface with zeolite seed crystals attached and the surface without zeolite seed crystals attached, thereby filling the micropores of the porous support with the zeolite seed crystals through the use of the pressure difference. The material for generating hydrogen according to the present invention can easily generate hydrogen by filling the material in a known reactor vessel, and by supplying steam thereto. Compared with conventional materials for generating hydrogen, the material for generating hydrogen of the present invention can be resistant to high temperatures for a long time, and can continually generate hydrogen.

Although the material for generating hydrogen depends on the size of reactor vessel applied, a flat disk shape of the material, for example, has an approximate diameter of 5 mm to 10 cm, preferably 10 mm to 5 cm, and has an approximate thickness of 0.5 mm to 1 cm, preferably 1 to 5 mm.

(System for Generating Hydrogen of the Present Invention)

In the system for generating hydrogen according to the present invention, hydrogen generation can be achieved continually by placing one or more sheets of zeolite membrane of the present invention in a known reactor vessel, and by continuously supplying water or steam to the reactor vessel. In particular, unlike the conventional method for generating hydrogen, in the system for generating hydrogen according to the present invention, there is no need to close once the reactor vessel during the reaction and the long periods of hydrogen generation can be achieved by continuously supplying water or steam. Furthermore, in the system for generating hydrogen of the present invention, there is no need to pressurize or depressurize the reactor vessel during the reaction, unlike the conventional method for generating hydrogen.

In particular, a preferred condition for the system for generating hydrogen according to the present invention is to generate hydrogen by using the apparatus for generating hydrogen according to the present invention, by keeping the temperature of the reactor vessel containing the zeolite membrane of the present invention in the range of 400° C. to 800° C., and by continuously supplying water or steam to the reactor vessel. By the procedure, hydrogen can be generated continuously for at least 10 hours.

Furthermore, placing pluralities of sheets of zeolite membrane in the reactor vessel makes it possible to achieve higher efficiency and longer periods of hydrogen generation compared with using one sheet of zeolite membrane.

The present invention is described in more detail referring to the examples. These examples are given only to explain the present invention, and they never limit the scope of the present invention.

### EXAMPLE 1

(Evaluation of Zeolite Membrane of the Present Invention)

Detail evaluation was given to the zeolite membrane according to the present invention. The detail evaluation is described below.

A Na-A zeolite powder (75 μm or smaller particle size, sold by Wako Pure Chemical Industries, Ltd.) was pulverized in a ball-mill for 24 hours. The pulverized zeolite powder was dispersed in ultrapure water using supersonic waves, and thus suspension was prepared (0.2 g/l, 50 ml). A 1 ml aliquot of the suspension was added dropwise onto a porous alumina support (substrate, with 10 mm in diameter and 1 mm in thickness). The seed particles were filled in the micropores of the porous alumina substrate after the opposite side of the substrate surface added dropwise was evacuated (to 10⁻¹ to 10⁻⁴ Torr) to suck the suspension. Then, the substrate was placed in an autoclave using a Teflon® table so that the seed particles-suction side faces downward. The hydrothermal treatment (75° C. for 3 hours) was conducted in a reaction solution (Na₂O:Al₂O₃:SiO₂:H₂O=50:1:5:1300).

The microstructure of thus obtained zeolite membrane was evaluated by SEM before and after the hydrothermal treatment.

FIG. 2 shows SEM images of surface and cross section of the porous alumina substrate, the micropores of which the seed particles before the hydrothermal treatment were penetrated into. In the cross sectional SEM image (the upper side of the SEM image is the seed particles suction face, FIG. 2(b)), the relatively large particles are the alumina particles, and the relatively small particles are the zeolite particles. This cross sectional image shows that the seed particles penetrate into the micropores to a depth of about 2 μm. In the surface SEM image (FIG. 2 (a)), it was confirmed that the seed particles deposited all over.

FIG. 3 shows SEM images of surface and cross section of the porous alumina substrate (zeolite membrane), the micropores of which the seed particles after the hydrothermal treatment were penetrated into. In the surface SEM image (FIG. 3(a)), it was confirmed that a membrane having high denseness is produced all over owing to the deposition of seed particles over the entire surface of the porous alumina substrate. In the cross sectional SEM image (FIG. 3(b)), it was confirmed that the spaces among alumina particles became dense, and that the thickness of the dense layer was about 5 to about 10 μm.

### EXAMPLE 2

(Production of Hydrogen From Water Using the Zeolite Membrane of the Present Invention)

The water-splitting characteristics of the zeolite membranes prepared in Example 1 were evaluated. The detail of the evaluation is described below.

One sheet of zeolite membrane (10 mm in diameter and about 5 to 10 μm in membrane thickness) prepared in Example 1 was fit in a stainless steel gasket (about 11 mm in inner diameter). The gap between the gasket and the zeolite membrane was sealed by a ceramic heat-resistant bond. Then the zeolite membrane was placed in the reactor vessel so that the gasket portion was sandwiched between stainless steel tubes, (refer to FIG. 1).

Subsequently, a gas (Ar) free of steam was supplied to the reactor vessel (at a rate of 1 ml/min) until the reactor vessel reached 450° C. When the temperature reached 450° C., the gas discharged from the reactor vessel was sampled (1 ml). The hydrogen concentration in the sampled gas was determined by gas chromatography. Separately, after almost completing the hydrogen generation in a dry atmosphere, a gas (Ar) containing saturated steam at 85° C. was supplied, and the hydrogen concentration was also determined.

The analytical condition is the following.

Argon gas flow rate: 1 ml/min

Capacity of reactor vessel: about 12 cm³

Gas chromatograph: GC-8A (Shimadzu Corporation)

The observed result is given in FIG. 4. The hydrogen concentration in the sampled gas was plotted against the elapsed time after the sample reached 450° C. in a dry Ar atmosphere. Under a dry atmosphere, the hydrogen generation caused by the splitting of water adsorbed in the zeolite was observed. After the hydrogen generation from the splitting of adsorbed water was completed, when a wet Ar was supplied, the hydrogen concentration in the sampled gas increased. The result showed that the supplied water was found to be split while passing through the zeolite membrane. Furthermore, it was found that hydrogen can be generated from a synthetic zeolite free from impurities, and that the micropores of zeolite contribute to the reaction.

### EXAMPLE 3

(Evaluation of the Duration Time of Hydrogen Generation by the Zeolite Membrane of the Present Invention, and Comparison Between Zeolite Membrane and Zeolite Powder Sample)

The characteristics for generating hydrogen of the zeolite membranes prepared in Example 1 were evaluated. In addition, the duration time of hydrogen generation using the zeolite membrane of the present invention was compared with that using a control sample (prepared by placing a zeolite powder, having the same weight to that of the zeolite layer produced on the surface and in the micropores of porous alumina substrate, on the porous alumina substrate). The detail is given as follows.

One sheet of zeolite membrane (10 mm in diameter and about 5 to 10 μm in membrane thickness) prepared in Example 1 was fit in a stainless steel gasket (about 11 mm in inner diameter). The gap between the gasket and the zeolite membrane was sealed by a ceramic heat-resistant bond. Then the zeolite membrane was placed in the reactor vessel so that the gasket portion was sandwiched between stainless steel tubes, (refer to FIG. 1).

Subsequently, a gas (Ar) containing saturated steam at 85° C. was supplied to the reactor vessel (at a rate of 1 ml/min) until the inside space of the reactor vessel reached 450° C. When the temperature reached 450° C., the gas discharged from the reactor vessel was sampled (1 ml). The hydrogen concentration in the sampled gas was determined by gas chromatography. The hydrogen concentration for a control sample was determined by the same procedure as above.

The analytical method is as follows.

Argon gas flow rate: 1 ml/min

Capacity of reactor vessel: about 12 cm³

Gas chromatograph: GC-8A (Shimadzu Corporation)

The observed result is given in FIG. 5. The horizontal axis is the elapsed time after the inside space of the reactor vessel reached 450° C., and the vertical axis is the hydrogen concentration in 1 ml of sampled gas. For the control sample, although the hydrogen generation firstly was observed from the adsorbed water in the zeolite, the hydrogen concentration significantly decreased with the lapse of time, and no hydrogen generation was observed. On the other hand, for the hydrogen generation using zeolite membrane, the hydrogen concentration was kept at about 3.2 to 3.5×10⁻³ vol % even after 24 hours or more had passed from the start of observation under the same experimental condition.

From the above results, it was found that the method for generating hydrogen using the zeolite membrane of the present invention stably generates hydrogen for a long time.

### INDUSTRIAL APPLICABILITY

The present invention can provide the method for producing zeolite membrane for generating hydrogen, which membrane has characteristics of being resistant to the reaction for a long time and in the high-temperature range, and has a characteristic of long-duration hydrogen generation. Furthermore, the present invention can provide the method for generating hydrogen for a long time using the zeolite membrane.

### BRIEF DESCRIPTION OF THE DRAWINGS

FIG. 1 shows an example of the apparatus for generating hydrogen.

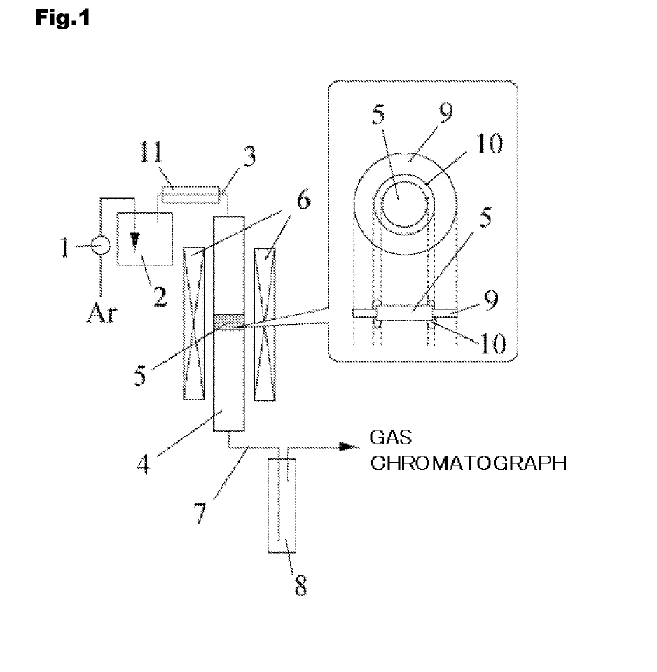

FIG. 2 shows SEM images of a porous alumina substrate, the micropores of which the seed particles before the hydrothermal treatment were penetrated into, FIG. 2(a) shows a surface, and FIG. 2(b) shows a cross section.

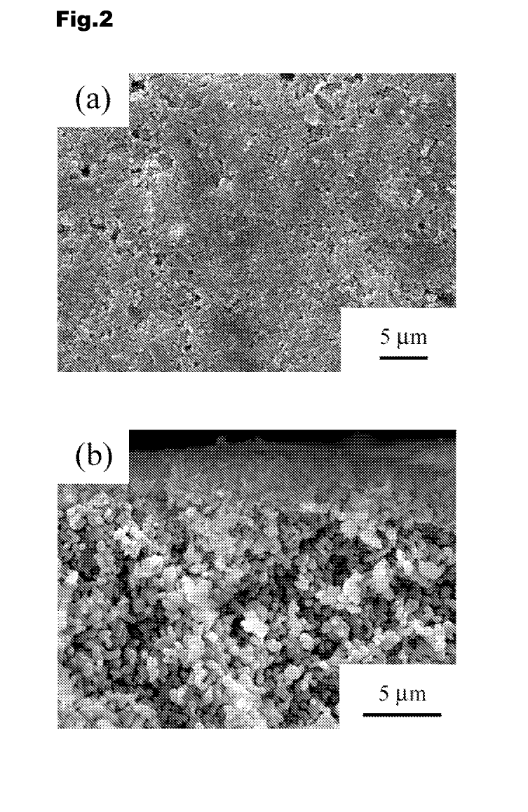

FIG. 3 shows SEM images of a porous alumina substrate the micropores of which the seed particles after the hydrothermal treatment were penetrated into, FIG. 3(a) shows the surface, and FIG. 3(b) shows the cross section.

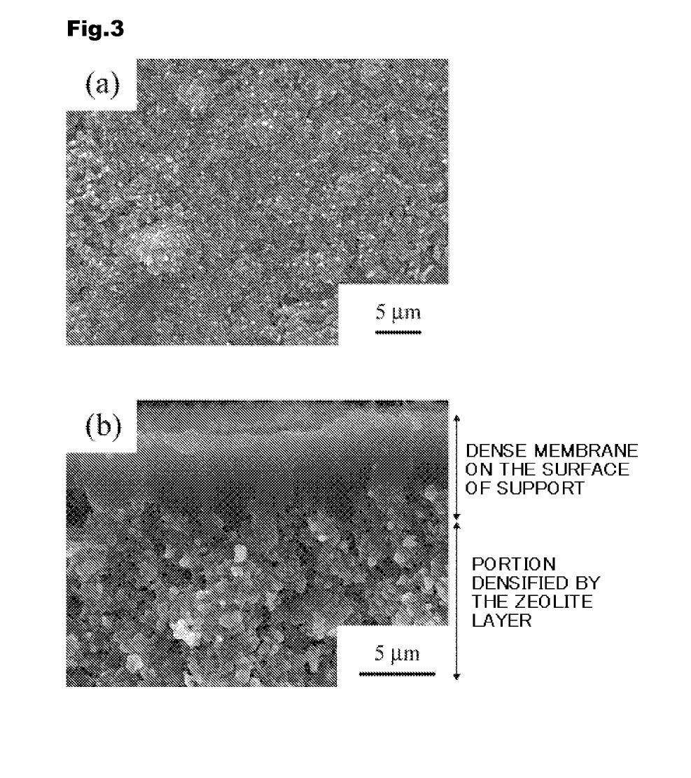

FIG. 4 shows the detection result of concentration of generated hydrogen.

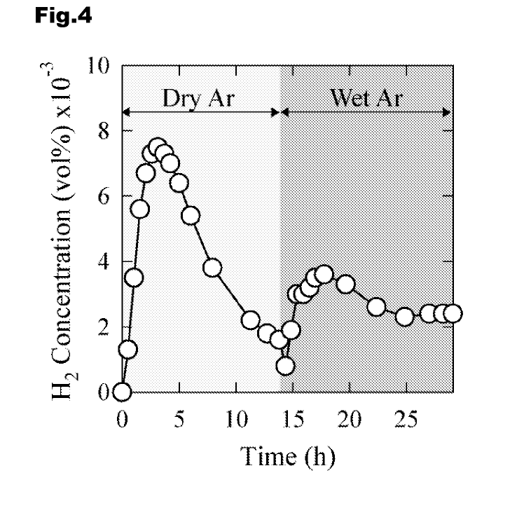

FIG. 5 shows evaluation of duration time of hydrogen generation.

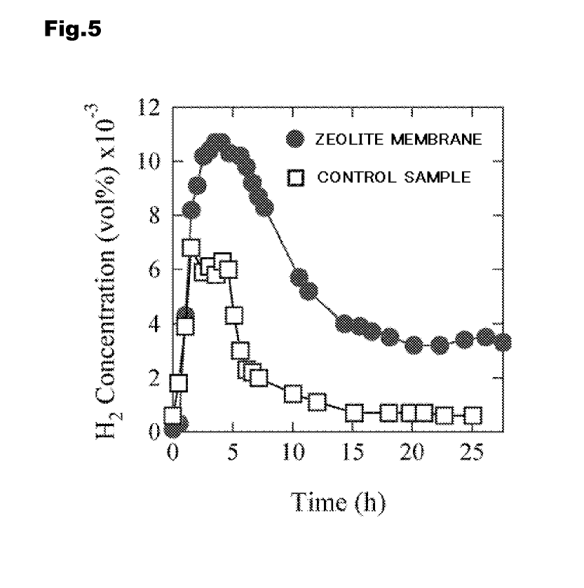

### EXPLANATION OF REFERENCE NUMERALS

1: a flow meter

2: a steam generator

3: a pipe

4: a vertical reactor vessel

5: a zeolite membrane

6: a heater

7: a pipe 7

8: a steam trap 8

9: a gasket

10: a ceramic heat-resistant bond

11: a preheater

What is claimed is:

1. A method for generating hydrogen comprising the step of bringing water or a water-containing gas, or steam or a steam-containing gas, into contact with a zeolite membrane, thereby splitting the water or the steam using the zeolite membrane as a catalyst.

2. The method for generating hydrogen according to claim 1, wherein said zeolite membrane contains a porous support and a zeolite layer produced on either surface of the porous support and in micropores thereof.

3. The method for generating hydrogen according to claim 2, wherein the step of manufacturing said zeolite membrane has the steps of: attaching zeolite seed crystals to either surface of the porous support; and generating a pressure difference between the surface with zeolite seed crystals attached and the surface without zeolite seed crystals attached, thereby filling the micropores of the porous support with the zeolite seed crystals through the use of the pressure difference.

4. The method for generating hydrogen according to any one of claims 1 to 3, wherein the contact temperature of said zeolite with said water or water-containing gas or with said steam or steam-containing gas is in the range of 400° C. to 800° C.

5. A material for generating hydrogen comprising a zeolite membrane composed of a porous support and a zeolite layer produced on either surface of the porous support and in micropores thereof.

6. The material for generating hydrogen according to claim 5, wherein the zeolite layer is produced in the micropores by the steps of: attaching zeolite seed crystals to either surface of the porous support; and generating a pressure difference between the surface with zeolite seed crystals attached and the surface without zeolite seed crystals attached, thereby filling the micropores of the porous support with the zeolite seed crystals through the use of the pressure difference.

7. The material for generating hydrogen according to claim 5 or claim 6, wherein the mean micropore size of said porous support is in the range of 200 nm to 5 mm, and the mean grain size of said zeolite seed crystals is in the range of 200 nm to 700 nm.

8. An apparatus for generating hydrogen comprising, at least: a water-supply means which supplies water or steam to a reactor vessel; a zeolite membrane; a reactor vessel containing the zeolite membrane; and a hydrogen-extraction means which extracts hydrogen generated in the reactor vessel therefrom.

9. A system for generating hydrogen comprising the apparatus for generating hydrogen according to claim 8, wherein the reactor vessel containing the zeolite membrane is kept at temperatures ranging from 400° C. to 800° C., and water or steam is continuously supplied to the reactor vessel, thus generating hydrogen continuously for at least 10 hours.

10. The system for generating hydrogen according to claim 9, wherein said zeolite membrane contains a porous support and a zeolite layer produced on either surface of the porous support and in micropores thereof.

11. The system for generating hydrogen according to claim 10, wherein the zeolite layer is produced in the micropores by the steps of: attaching zeolite seed crystals to either surface of the porous support in said zeolite membrane; and generating a pressure difference between the surface with zeolite seed crystals attached and the surface without zeolite seed crystals attached, thereby filling the micropores of the porous support with the zeolite seed crystals through the use of the pressure difference.
